(19) United States
(12) Patent Application Publication
(10) Pub. No.: US 2016/0307245 A1
(43) Pub. Date: Oct. 20, 2016

(54) COMPUTER IMPLEMENTED SYSTEMS AND METHODS FOR ASSET TRANSFER

(71) Applicant: CFPH, LLC, New York, NY (US)

(72) Inventors: Howard W. Lutnick, New York, NY (US); Thomas D. Bradshaw, New York, NY (US); Miller A. Mark, New York, NY (US); Gerard Phelan, New York, NY (US)

(21) Appl. No.: 14/968,891

(22) Filed: Dec. 14, 2015

Related U.S. Application Data
(60) Provisional application No. 62/091,395, filed on Dec. 12, 2014.

(51) Int. Cl. G06Q 30/06; G06Q 20/10

(52) U.S. Cl. CPC G06Q 30/0605; G06Q 20/102

(57) ABSTRACT

Various embodiments are directed to a system and method for matching providers (e.g., lenders) and receivers (e.g., borrowers or purchasers) of a good (e.g., a tangible product or loan funds). The provider may specify one or more parameters of a commitment to provide the good, such as quantity and delivery specifications. Before a receiver accepts the commitment, the provider may provide a portion of the total commitment (e.g., a margin amount of a loan or a percentage of a quantity of a tangible product). A one-time or continuing commitment fee may be paid to the lender for providing the loan commitment. The commitment fee may be based on the loan commitment amount and/or the margin amount. When a borrower accepts the terms of the loan commitment, the lender may fund the remaining balance of the loan principal amount. If the lender fails to fund the remaining balance, the lender may forfeit the margin amount.

### RELATED APPLICATIONS

This application claims the benefit of U.S. Provisional Application Ser. No. 62/091,395 filed Dec. 12, 2014, the disclosure of which is incorporated by reference herein in its entirety.

### BACKGROUND

Parties in need of products or services often seek them directly from providers of those products and services. For example, customers may shop at retailers like Walgreens or Walmart.com, and they may seek loans directly from their banking institutions such as Citibank or Wells Fargo. Shopping parties may compare prices from multiple retailers selling the same or similar products. This type of shopping can be time-consuming, and such shopping is typically limited to a relatively small number of possible providers. More complicated transactions involving a plurality of parameters such as personal loans can be even more time and labor-intensive.

Various companies enable a plurality of providers of products (such as loan providers) to be matched with a plurality of possible acquirers of those products (such as borrowers seeking a loan). For example, the Lending Club, a publicly traded company, matches lenders and borrowers. Borrowers may request specific loans, and lenders may input specifications about loans they are willing to make or invest in. In some systems, when counterparties are matched, the providers sometimes fail to deliver on their committed obligations. This can lead users to suspect that a substantial portion of advertised products or services are actually not available and lead to wasted time and effort from failed or cancelled transactions, decreasing the overall effectiveness of the platform.

### BRIEF SUMMARY

In some embodiments, one or more potential providers (e.g., of a product, service, or loan) can specify a commitment to provide a “principal” amount of a product (e.g., a principal loan amount). The commitment may be available to and/or selectable by one or more potential recipients (e.g., potential borrowers), e.g., via a website or central server. The provider(s) may post a “margin amount” of the total principal amount, such as a percentage of the principal loan amount. The provider(s) may earn a commitment fee (e.g., a percentage of the margin amount, or a percentage of the principal value of the loan committed), e.g., in exchange for providing the commitment. After the commitment has been entered, a potential recipient (such as a borrower) may select the commitment and request the principal. At this point, the principal may be provided to the borrower. The principal may be funded partially from the margin amount (e.g., which may already have been provided by the provider) and the remaining balance of the principal, which may be provided by the provider within a specified period of time, e.g., pursuant to the terms of the commitment. If the provider fails to provide the remaining balance within the specified period of time, the provider may surrender all or a portion of the margin amount (e.g., to a central broker and/or the borrower), and no further commitment fee payments may be made to the provider.

### BRIEF DESCRIPTION OF THE FIGURES

FIG. 1 depicts a system according to at least one embodiment of the systems disclosed herein.

FIG. 2 depicts a flow chart according to at least one embodiment of the systems disclosed herein.

### DETAILED DESCRIPTION OF EXEMPLARY EMBODIMENTS

Accordingly, in some embodiments, a computer-implemented system over a network may connect a plurality of providers of commitments (e.g., loan commitments) to a plurality of recipients (e.g., possible borrowers). Compared to conventional systems, a computer-implemented system that networks a plurality of providers and recipients achieves greater liquidity and price transparency because it dramatically reduces the amount of time and effort needed to shop for products and services. The ability to electronically search a single database having information organized in a consistent format is far superior to bespoke methods of comparison shopping among different vendors, which also consumes significant time for the shopper and provider salespeople. Providers/lenders benefit by reaching a larger base of potential customers/borrowers, and borrowers/customers achieve greater price transparency and product availability. With the greater availability resulting from a larger number of participating lender/providers, customers/borrowers who otherwise may not find a loan/product that meets all of their specifications may find it with the click of a few buttons on a search engine.

Furthermore, the system opens up lending and product/service provision to a number of entities that otherwise may not participate due to the otherwise high marketing and sales costs. Again, the greater liquidity benefits customers.

Substantially instantaneous communication offered by a computer network linking providers, recipients, and margin/escrow agents enables a transaction to be offered, negotiated, and closed very quickly compared to conventional systems. The greater speed further enables all parties to modify their commitments and product/service specifications to respond quickly to the market, e.g., a change in interest rate or a change in the price of oil or another commodity. Effective “prices” tend to be more accurate and more accurately reflect the capabilities of each provider, and this further leads to commitments that are more likely to be kept by providers.

Commitment fees incentivize providers to submit commitments, as each commitment can earn commitment fee payments and thus a return on capital even when there is no customer.

Surrenderable margin terms incentivize providers to submit commitments that they can actually keep, since failure to meet their commitments can result in a loss of margin. As a result, recipients can trust that advertised commitments will be delivered as promised. This significantly reduces many of the problems of conventional systems that do not adequately “punish” offenders who erode trust in the system.

Furthermore, by providing at least a portion of a surrendered margin to the recipient who suffered the provider's default, recipients can trust that even if a given commitment falls through, they will be compensated for their loss.

Each of these features engenders a robust platform that benefits and incentivizes both providers and recipients.

Accordingly, various embodiments enable providers to provide product/service commitments with a surrenderable margin and earn a commitment fee before a commitment is accepted.

For example, in some embodiments, one or more potential lenders can specify a loan commitment associated with a principal loan amount. The loan commitment may be available to and/or selectable by one or more borrowers, e.g., via a website or central server. The lender(s) may post a margin amount of the total loan, such as a percentage of the principal loan amount. The lender(s) may earn a commitment fee (e.g., a percentage of the margin amount, or of the principal value of the loan committed), e.g., in exchange for providing the loan commitment. After the loan commitment has been entered, a borrower may select the loan and request the loan principal value. At this point, the loan principal may be provided to the borrower. The loan principal may be funded from the margin amount (already provided by the lender) and the remaining balance of the loan, which may be provided by the lender within a specified period of time. If the lender fails to provide the remaining loan balance within the specified period of time, the lender may surrender the margin amount (e.g., to a central broker and/or the borrower), and no further commitment fee payments may be made to the lender.

Various exemplary embodiments are directed to a system and method for matching providers (e.g., lenders) and receivers (e.g., borrowers or purchasers) of a good (e.g., a tangible product or loan funds). The provider may specify one or more parameters of a commitment to provide the good, such as quantity and delivery specifications. Before a receiver accepts the commitment, the provider may provide a portion of the total commitment (e.g., a margin amount of a loan or a percentage of a quantity of a tangible product). A one-time or continuing commitment fee may be paid to the lender for providing the loan commitment. The commitment fee may be based on the loan commitment amount and/or the margin amount. When a borrower accepts the terms of the loan commitment, the lender may fund the remaining balance of the loan principal amount. If the lender fails to fund the remaining balance, the lender may forfeit the margin amount.

In some embodiments, a centralized system may match lenders and borrowers. Lenders and/or Borrowers may post desired loan specifications. Borrowers and/or Lenders may search posted loan specifications and find a desired loan. Borrowers and/or Lenders may accept a specific loan and thereby cause a loan to be in effect between the relevant Lender(s) and Borrower(s).

In some embodiments, a lender may specify one or more terms of potential loan, such as a loan amount (e.g., a $100,000 loan amount with a 5-year term to borrowers with a 700+ credit score at an interest rate of 4% or more.) A lender may post the specifications to the central server. The lender may “commit” to do the specified loan in the event that a Borrower accepts the terms of the specified loan.

In some embodiments, the lender may transfer a “margin” or percentage of the loan to the central system (e.g., $5000 of the $100,000 loan principal).

In some embodiments, the central system may pay the lender a number of basis points on the total loan amount (e.g., 50 basis points=$500/year) in exchange for the lender putting up the loan offer. (This is effectively a “commitment fee” for the “loan commitment.”)

In some embodiments, a Borrower may search for and find the specified loan parameters, and then agree to the terms of the Lender's proposed loan. This may occur after the lender has received one or more payments for the loan commitment.

Once accepted by a borrower, the Lender may transfer the remaining loan balance (e.g., $95,000). The remaining balance may be due within a certain period of time (e.g., within a certain period of time from when the borrower accepts the loan terms, or from when the lender is notified). The certain period may comprise a number of possible time periods, such as substantially immediately (e.g., within a few milliseconds or seconds of notice), within minutes, hours, days, next business day, end of week, end of month, or other time. The Borrower may receive the total $100,000, and the Lender and Borrower may proceed according to the agreed loan contract (e.g., the terms of the commitment). It should be appreciated that in some embodiments, an acceptance by a recipient of a commitment by a provider may comprise a (binding) contract.

However, if the Lender does not transfer the remaining balance within the required period of time, then the Lender may forfeit the margin amount. For example, if the Lender is required to transfer the funds by the end of the business day and fails to do so, the margin amount may be surrendered to one or more parties (e.g., to a central broker entity, escrow agent, borrower, or other party).

In some embodiments, if the lender is unwilling or unable to transfer the remaining balance of the loan principal, the margin amount may no longer belong to the lender. In some embodiments, all or a portion of the margin amount may be kept or paid to a central broker, the borrower, a transaction agent, and/or the original lender.

In some embodiments, the lender may be required to fund the remaining balance within a specified period of time from acceptance by a recipient/borrower (e.g., ten minutes, one hour, five hours, end of day, next business day, end of week, two days, end of month, or another time period).

In some embodiments, the lender may be required to fund the remaining balance substantially immediately, e.g., automatically electronically funded (e.g., from a designated lender account) in response to an electronic message that the funds are due. For example, the lender's account may be configured such that it will automatically transfer the remaining proceeds (if there are sufficient funds in the account) in the event the loan is accepted.

In some embodiments, if the Lender fails to deliver the proceeds (e.g., within a specified period of time), the Borrower may be given the opportunity to cancel or decline the loan, to modify the loan terms, or to propose new loan terms.

In some embodiments, if the lender fails to fund the remaining balance, then the loan parameters may be offered to one or more other lenders. For example, one or more other lenders may choose to provide a loan according to the designated loan parameters and/or terms as accepted by the Borrower. For example, specifications of a loan or other commitment may be posted to a trading/matching platform.

In some embodiments, if the loan is fulfilled by one or more other lenders (e.g., within a certain period of time), then all or a portion of the (surrendered) margin may be paid to the lender(s) who fulfill the loan. The amount of margin paid may depend on how soon the new lender(s) fund the loan balance. For example, the pay-able portion of the margin may decay over time (e.g., linearly, exponentially, or other decay function) after the original lender forfeits the lending obligations.

In some embodiments, providers may know (or not know) the terms under which they get to keep all or a portion of the surrenderable margin. Such terms may be discretionary to the system. In some embodiments, such terms of forfeit or non-forfeit may be clearly specified to all parties in advance.

In some embodiments, if the loan is fulfilled by one or more lenders (e.g., within a certain period of time), then all or a portion of the surrendered margin may be refunded to the lender. In some embodiments, the refundable portion of the margin may decay over time (e.g., linearly, exponentially, or other decay function), such that the earlier the loan is fulfilled by another lender, the more of the margin that is refunded to the Borrower or to the new Lender/Provider. The margin may be completely surrendered if the Borrower declines to proceed with the loan.

In some embodiments, the lender may pay an additional fee (and/or surrender one or more payments associated with the loan commitment fee) to extend the deadline for delivering the full loan proceeds, e.g., thereby effectively buying extra time for delivering the remaining loan proceeds (e.g., the loan principal minus the margin already paid). For example, if loan proceeds would be due within three days of a borrower accepting the loan, the lender may extend the deadline from three days to five days (or a week or another time) by paying (or surrendering or foregoing) an amount.

In some embodiments, a provider who has or will fail to meet one or more obligations of an accepted commitment may attempt to find a replacement commitment (e.g., from another provider). In some embodiments, if the provider finds an acceptable replacement (e.g., acceptable to the recipient), the provider may keep all or a portion of the margin amount. In some embodiments, a provider may effectively meet the obligations by “supplementing” another commitment. For example, if a provider commits to provide 1000 gallons of fresh water (or potable water) but cannot meet this obligation, the provider may accept a different commitment to provide 900 gallons of fresh water, and then supplement this provision with 100 gallons (e.g., from its own reserves or via yet another commitment) to meet the 1000 gallon requirement. Alternately, if a provider commits to provide a $100,000 loan at a 3.5% interest rate but cannot meet this obligation, the provider may obtain a loan (e.g., on behalf of the recipient) at a slightly higher interest rate and pay the “additional” interest out of its own pocket. In some embodiments, the system may automatically attempt to satisfy a breached commitment using a similar available commitment (e.g., with perhaps more unfavorable price terms), and the difference in price may be funded from the margin amount in order to effectively deliver the original commitment to the recipient (e.g., and thus make the recipient “whole”). In these ways, a provider may effectively meet its obligations and avoid surrendering all or a portion of the margin amount, even though in some embodiments it may take a small or big loss (but perhaps less of a loss than surrendering the margin amount).

In some embodiments, a lender whose loan commitment has been accepted may transfer the lender's loan obligations to another lender. For example, the lender may be unwilling or unable to pay the remaining balance of the loan principal. Instead of surrendering all or a portion of the margin, the lender may transfer the loan to another lender who funds the loan principal amount. In some embodiments, the margin may be refunded to the original lender. In other embodiments, portions of the margin may be paid to a central broker, the original lender, the new lender, the borrower (e.g., in addition to receiving the full principal amount), and/or other entities.

In some embodiments, the lender's loan obligations may be auctioned in a secondary market, e.g., during an auction period (e.g., after the lender fails to fund the remaining loan balance, or after the lender indicates that the lender will not fund the remaining balance). For example, one or more lenders may bid on taking over the lending obligations and all (or a portion of) the margin amount. For example, during a bidding period, one lender may offer to fund the full loan amount and fulfill the loan terms in exchange for a percentage of the margin amount (e.g., 50% of the margin amount). Another lender may offer to fund the full loan amount and fulfill the loan terms in exchange for 40% of the margin amount. Another may bid 30%, etc. In some embodiments, the best offer may be selected, e.g., by a central broker and/or the borrower. The winning lender may receive the designated portion of the margin amount (e.g., 30%). The remaining amount of the margin may be paid to one or more parties, e.g., the borrower, a central broker, escrow agent, original lender, and/or one or more other parties.

In some embodiments, in the event that the provider/lender is unwilling or unable to fulfill the commitment/loan obligations, the lender and borrower may renegotiate the loan. For example, the lender and borrower may agree to reduce the loan principal by a percentage (e.g., 50%). The lender may receive a refund of all or a portion of the loan (e.g., 50%).

In some embodiments, loan parameters and terms may be determined based on a variety of criteria, such as information about the borrower, such as rating information. For example, a lender may charge a higher interest rate to a borrower with a low credit score, and charge a lower interest rate to a borrower with a high credit score.

In some embodiments, rating information may be determined, provided, and/or stored concerning one or more potential borrowers. For example, rating information may comprise the following information about the potential borrower: a current or past credit score (e.g., from one or more credit rating agencies), employment history, education history, degrees obtained, courses taken, GPA, address, location of residence and/or birth (e.g., neighborhood, city, state, county, country, etc.), prior and current income, information about other credit and credit transactions, other prior or current loans, repayment history, information about friends, contacts, posts, and online behavior on social media sites such as facebook, linkedin, and twitter (etc.), and other information.

In some embodiments, more favorable loan terms may be provided when the borrower has (or will have) a loan from one or more friends and/or family that is subordinate to the lender's loan. For example, a lender may predict a higher chance of repayment (which may translate into a lower interest rate or other favorable terms) for a loan that is senior to a significant unpaid loan from one or more friends, family, or social contacts of the borrower. (E.g., the lender may predict that a borrower has greater incentive to repay the loan in an effort to see that the lender does not default on the subordinate loan to the one or more friends or family members.)

In some embodiments, rating information may be determined for potential providers. For example, rating information may provide information about or be determined based on information about: how often a provider (such as a lender) cancels or fails to consummate commitments (such as loan commitments); the creditworthiness of a provider; a bond rating of a provider (e.g., a corporate bond rating from Moody's); information on a financial statement of a provider (e.g., 10-Q or 10-K) concerning a financial measurement such as total assets, cash flow, market cap, etc.; a rating concerning a particular parameter such as delivery time (e.g., a rating of how quickly the provider delivers upon commitments, e.g., how quickly a lender typically provides a borrower with the principal of a loan once the borrower accepts the commitment); and other ratings.

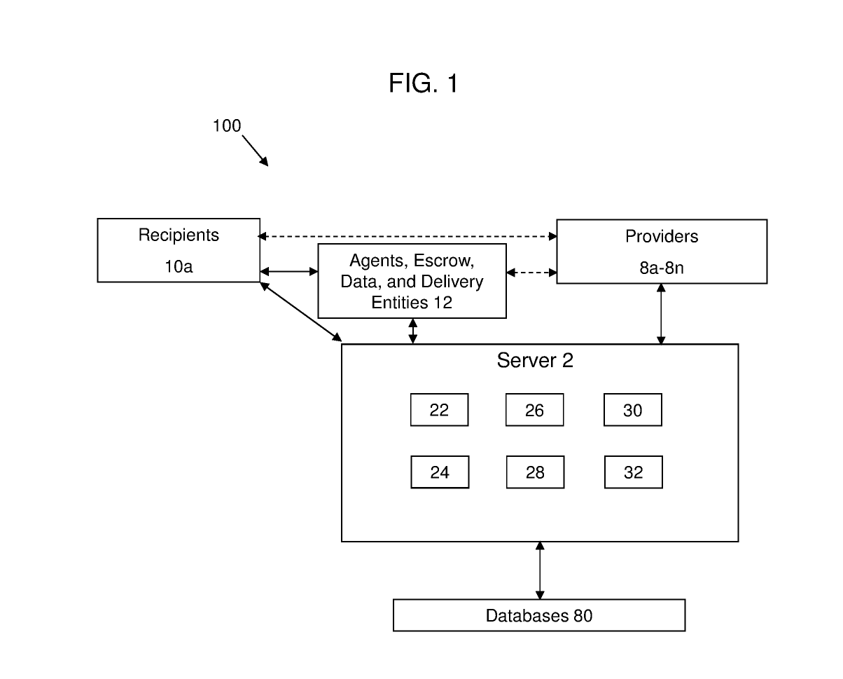

FIG. 1. Exemplary System

Some embodiments of the present invention provide systems and methods for transacting products and/or services, such as loans having a commitment fee and/or a surrender-able margin. FIG. 1 depicts a system according to at least one embodiment of the systems disclosed herein. System may comprise one or more computers (e.g., in communication over a network) and other computing elements coupled to databases and programmed with software that instructs the computing elements to perform the functions described herein.

The system 100 may comprise one or more servers 2 coupled to one or more databases 80, one or more providers 8a-8n, one or more recipients 10a-10n, and one or more agents, escrow, and data entities 12 (collectively called “agents”). The providers 8a-8n, recipients 10, agents 12, and server 2 may each communicate with one other. Recipients 10a may also communicate with other recipients 10b, and likewise providers 8a may communicate with other providers 8b, and agents 12a may communicate with other agents 12b. Recipients 10 and providers 8 may collectively be referred to herein as “users” of the system.

System 100 and server 2 may perform the commitment management, communication, pricing, and processing functions described herein.

Server 2 may comprise one or more processors, computers, computer systems, computer networks, and or computer databases. Server 2 may comprise modules. Server 2 may also comprise one or more databases, such as databases 80. Server 2 may communicate with recipients 10, providers 8, and agents 12. For instance, server 2 may communicate with a user 10, 8 computer, such as a browser of a user computer, e.g., over the internet.

In some embodiments, recipients may specify parameters of one or more products and/or services, e.g., via a user interface at a user computer. In some embodiments, recipients may specify parameters of one or more commitments to provide a product or service, e.g., via a user interface at a user computer. Such information may be transmitted to server, other users, and/or agents 12.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Recipients 10a-10n may comprise one or more recipients, such as borrowers, purchasers, acquirers, and traders. Recipients 10 may comprise one or more human persons, computers, terminals, users, traders, trading entities, or other entities. Recipients 10 may interact with agents 12, server 2, and/or other recipients 10. As used in this application, recipients 10a-10n may also refer to a user's interface to other system 100 components (like server 2), such as a user's PDA or computer or a program running on a user's computer such as a computer web browser like Internet Explorer™, which may communicate with providers 8, agents 12, and/or server 2.

Provider(s) 8 may comprise any person (or group of persons), processor, information service, or other entity that publishes or otherwise provides information relating to one or more products and services, commitments, rating information, credit information, financial instruments, markets, trading platforms, traders, orders, or other financial- or trade-related information. In some embodiments, the data may include information that may be of interest to or used by a user 10 or server 2.

In some embodiments, a provider may comprise a consortium of persons or entities that share parts of a single commitment. For example, a lending group of 10 persons (or lending entities) may commit to provide a $1,000,000 loan that is funded by $100,000 from each entity within the provider group. The providing of crowd-sourced products and services (such as crowd-sourced loans) is contemplated herein.

Users (e.g., recipients 10 and providers 8) may provide information in real time, as information is created or as it first becomes available to the general public, or at another time. Users may provide such information in any one or more of a variety of forms and means such as video, audio (e.g., radio broadcast), text (e.g., stock ticker-type information), or other data that may convey information. Data may be provided at a variety of different timings. In some embodiments, data may be provided in periodically, continuously, or continually, e.g., via a data feed (e.g., a stream of data that includes real time updates of trading-related information). In some embodiments, data may be provided after an event, e.g., a trade or submission of an order.

In some embodiments, recipients 10 and providers 8 may provide to server 2 (and/or agents 12 and/or recipients 10) information concerning products, services, and/or commitments to provide products and/or services.

Agents 12 may comprise one or more agents, escrow entities, data entities, delivery entities, and other parties that may interact with providers, recipients, server, and other components to facilitate the transactions and delivery requirements discussed herein. For example, agents 12 may comprise one or more entities that hold “margin” quantities, e.g., in escrow.

For example, agents 12 may comprise one or more trading-related entities such as an escrow entity, settlement system, broker or other entity that interacts with users, recipients, providers, and/or server, but is separate from those entities.

The server 2 may comprise a computer, server, hub, central processor, or other entity in a network, or other processor. The server 2 may comprise input and output devices for communicating with other various system 100 elements. In some embodiments, the server 2 may comprise a system that can process information relating to commitments and desired products and/or services and that can match recipients and providers. Server 2 may comprise a trading platform, an exchange, an order matching system, or other processing system.

In some embodiments, the server 2 may be comprised in an end user's computer 10, e.g., as a toolbar in a user's web browser or another program running on the user's computer.

As shown in FIG. 1, server 2 may comprise a plurality of modules. Each module may comprise a processor as well as input and output devices for communicating with other modules, databases, and other system elements.

User interface module 22 may communicate with users (e.g., recipients and providers).

User interface module 22 may cause information to be output to a user, e.g., at a user output device such as a display device (e.g., a display device at a user terminal), a speaker. The information outputted to a user may be related to a user account, preferences, specifications concerning products and services, and commitments, and other information described herein. User interface module may communicate the information electronically, e.g., via networked communication such as the internet (e.g., in an email or webpage), telecommunication service, etc. In some embodiments, user interface module 22 may comprise input devices for users to communicate trading-related information.

User preferences module 24 may receive, identify, or determine user preferences and specifications concerning one or more commitments, products, and/or services. For instance, the module may receive the specifications from a user interacting with a user interface.

The module 24 may also receive such specifications from an automated user terminal. The module may also determine specifications and/or preferences based on a program that automatically determines user preferences and/or specifications concerning one or more commitments, products, and/or services. Such specifications and preferences may comprise information about parameters for a commitment or product or service. For example, once a particular loan commitment is transacted from a lender, module may automatically cause a specification of an identical commitment to be provided to the system, e.g., provided the lender has sufficient funds to immediately provide the required margin amount and is expected to be able to deliver the principal.

Rating information module 26 may determine financial and other rating information associated with one or more commitments, products, services, orders, trades, financial instruments, portfolios, indices, financial metrics, and other financial information.

Search and matching module 28 may search for and/or identify and/or solicit one or more commitments, products, services, e.g., from the market and/or from one or more specific counterparties. For instance, search and matching module may search one or more financial databases (e.g., a database that stores orders or counter-party preference information), e.g., via the internet, to determine one or more commitments or products/services that satisfy one or more parameters, such as parameters based on preferences from a user.

Search and matching module 28 may also manage the matching of recipients and providers. For example, search and matching module may cause a list of possible products/services and commitments to be displayed to relevant parties, which may select such product/service and/or commitment for a transaction.

For example, search and matching module 28 may cause a plurality of possible commitments to be displayed to a specific recipient (e.g., a recipient that meets the required credit score and/or other standards for accepting the specific commitment). For example, the recipient may run a search for products that match various search criteria, such as loans that match various interest rate and principal parameters. The recipient may select and accept a specific one of the possible commitments (e.g., from the search results). In some embodiments, a provider may select one of a plurality of product/service specifications from a recipient (e.g., those that the provider is qualified to see based on the provider's credit rating and/or other criteria), and may select and agree to provide such product/service.

In some embodiments, search and matching module 28 may run a competitive auction process similar to that available for Treasuries on the eSpeed™ trading platform. Providers and recipients may submit “offers” and “counteroffers” that define terms of products/services and commitments. By analogy, recipients may submit “bids” to acquire/lease/hold/possess a product/service, and providers may submit “offers” to provide a product/service. Parameters of the bids/offers may be analogous to the price on a trading platform. For example, a lower interest rate on a loan is analogous to a better “price” for bidder/recipients. Accordingly, providers and recipients may submit orders and counterorders that may be accepted by one another. Orders may be “hit” or “lifted.” In some embodiments, orders may specify “price improvement,” e.g., in the form of more desirable parameters (or a more desirable range) for the contra side.

In some embodiments, search and matching module 28 may aggregate the available commitments from a plurality of different sources (e.g., a plurality of different lenders or lending aggregators). Accordingly, the commitments available via server 2 may comprise all commitments available from all possible (or many possible) sources.

Margin and commitment module 30 may determine and associate one or more margin amounts with one or more commitments, e.g., as described herein. For instance, margin module 30 may determine a margin amount for a particular commitment, e.g., based on a total amount of commitment (e.g., a percentage of the total). For instance, margin module 30 may determine a quantity or value (such as a margin amount) that an entity such as a provider must provide (e.g., to agent 12 or a server account) so that the commitment can be validated.

In some embodiments, the same margin amount may be used as the margin to cover a plurality of different commitments. For example, a single $5,000 margin amount may “support” several different possible $100,000 loans at different interest rates for borrowers of different credit scores. Each loan may be separately selectable. In some embodiments, if one of the loan commitments is accepted, the other commitments will be disabled (e.g., to prevent two or more of the loans to be accepted at the same time). In some embodiments, the “single” margin that supports multiple commitments may need to be larger than a “regular” margin would otherwise be. For example, if a single margin is supporting three different $100,000 loan commitments, then the margin may be $8,000 instead of $5000 to reflect the possibility of multiple margins being accepted simultaneously or substantially simultaneously.

In some embodiments, a provider may have standing instructions to automatically “renew” or re-transfer a new margin amount each time a commitment is accepted. Accordingly, a lender may have standing instructions for its account to automatically transfer a new $5000 margin amount each time a $100,000 loan commitment is accepted. In some embodiments, for one or more live commitments, a provider may have standing instructions to automatically re-submit an identical commitment whenever a commitment is accepted, e.g., up to some threshold number of times (or threshold total amount, or other predetermined threshold).

Margin and commitment module 30 may also validate margin amounts (e.g., by determining that a margin amount was delivered and/or transferred to the correct entity or account) and commitments (e.g., by validating that all commitment pre-conditions are satisfied, such as that the margin amount has been transferred). Margin amounts may comprise funds, products, and interests (such as title or license) in or to such products and/or services. In some embodiments, a margin amount may comprise a physical product that must be physically delivered, e.g., to a specific address. Module 30 may validate the margin amount once various conditions are satisfied, such as confirmation of shipping or confirmation of delivery of the margin amount.

In some embodiments, a margin amount may comprise a right to an amount of bandwidth, e.g., internet, cellular, or other bandwidth for data transfer. The margin amount may comprise a legal right to the bandwidth, e.g., provided by a holder of a licensee or owner of the bandwidth. For example, an amount of bandwidth owned or leased by AT&T (that covers a period of time, e.g., in the future) may be legally transferred to an escrow entity as part of a commitment by AT&T (or other provider) to provide a larger amount of bandwidth for the relevant period of time. If AT&T or the other provider defaults on one or more of its commitment obligations, all or a portion of the margin amount of bandwidth (e.g., the legal right to such bandwidth) may be surrendered to a server account, an escrow agent, and/or the relevant recipient. Accordingly, such legal rights may be held (and may be usable by) a party other than the original provider, such as AT&T.

In some embodiments, routers may be physically configured to allow the new holder(s) of such rights to bandwidth to use such bandwidth, e.g., without additional consent from AT&T. For example, if AT&T defaults on its commitment to provide 100 GB/s of bandwidth to Republic Wireless for a period of one week starting two months from the present, a transferred margin amount of 5 GB/s may be transferred to Republic Wireless for its use during the relevant time period. The relevant routing algorithms for the relevant routers may be physically modified accordingly.

In some embodiments, margin and commitment module 30 may determine and pay commitment fees, e.g., for validated commitments. Commitment fees may be calculated as a percentage of a commitment amount and/or margin amount. Commitment fees may be paid one time or periodically in the same or different amounts. In some embodiments, a commitment fee may comprise a periodic payment of a number of basis points (e.g., 3 basis points or 25 basis points) of the committed quantity (e.g., 3 basis points on a $100,000 committed loan paid every month). In some embodiments, a commitment fee may be calculated as an interest payment on the margin amount.

In some embodiments, a commitment fee may be calculated based at least in part on one or more criteria, such as commitment parameters, interest rates, and any a difference between commitment parameters and similar “market-rate” parameters, e.g., parameters from commitments that were actually recently accepted by recipients, and/or a likelihood that a recipient will accept the commitment, among other criteria. For example, a commitment to loan an amount at an exorbitant interest rate for a borrower with a relatively high credit score may earn a lower commitment fee than a commitment to loan an amount at an interest rate that is more in line with market interest rates for borrowers of various credit score thresholds.

In some embodiments, margin and commitment module 30 may also handle other fees and payments related to system 100. For example, module 30 may coordinate subscriber fee payments made (e.g., periodically) by providers and/or recipients, e.g., for access to the matching platform. Module 30 may also coordinate payment of fees such as loan origination fees, loan application fees, loan recordation fees, title fees, taxes, etc. Payments of these fees may be made by and to any relevant parties and other entities such as government entities.

It should be appreciated that system may monitor and manage an accepted commitment, e.g., to ensure that each party meets its obligations. If a party fails its obligations, the system may take remedial measures. For example, the system may cause a provider to surrender a margin amount, and system may charge fees to recipients who fail to meet their obligations. For example, if a recipient fails to meet it loan repayment obligations, the server 2 may submit a notice to a credit authority or bill payment collector, and/or collateral posted by the recipient (e.g., to an escrow or agent) may be wholly or partially forfeit, e.g., to server 2 and/or the relevant provider.

Surrender module 32 may determine a surrender amount, e.g., related to a margin amount for a particular commitment, e.g., responsive to a cancellation or failure by a provider, such as a failure to satisfy one or more requirements of a commitment to a recipient (e.g., a failure to deliver the committed amount to the recipient within a specified period of time such as three days or two weeks.

Surrender module 32 may determine a surrender amount based on one or more criteria, such as how much time elapsed between an acceptance of a commitment and the failure condition(s); historical information concerning prior failures to meet conditions (e.g., a number of times a specific provider has failed to satisfy one or more prior commitments); the availability of substitute commitments (e.g., the availability of one or more alternate $100,000 loans with similar or identical specifications, and whether the recipient accepts it); the extent to which one or more commitment obligations were violated (e.g., an extent of a delay in delivering a committed amount, or partial delivery); remedial measures taken by the provider (e.g., advance notice of a future breach of the commitment before such breach occurs, e.g., an advance notice that a committed amount will not be delivered on time); and other factors. In some embodiments, only a portion of a margin amount may be surrendered, e.g., if a recipient accepts an alternate commitment within a predetermined period of time (e.g., 24 hours, two days, five days, one week, two weeks, one month, etc.) after acceptance of an original commitment or the provider's violation of one or more commitment requirements (e.g., delivery requirements).

In some embodiments, a matched provider and recipient may negotiate an amount of surrender. For example, if a recipient wishes to take an alternate commitment instead of wait for delivery of an original commitment whose delivery conditions were violated by a provider, the recipient may elect to take a portion of the original margin amount (e.g., half or a quarter of the margin amount), and the remainder of the surrendered margin amount may be paid to server and/or returned to the original provider. For example, in some embodiments, matched recipients and providers may communicate back and forth offers and counteroffers related to the surrender amount.

In some embodiments, all or a portion of a surrendered amount may be transferred to one or more agents, one or more recipients, one or more providers, and/or server. For example, a margin amount may be surrendered partly to the relevant recipient and partly to a server account, e.g., in equal or unequal amounts. In some embodiments, a provider who surrenders a surrender amount may receive all or a portion of the margin amount back, e.g., if and/or when the relevant recipient accepts an alternate commitment.

As shown in FIG. 1, a database 80 may be coupled to the server 2. The database 80 may comprise a plurality of databases as described below. Databases 80 may store information about users, trading products, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

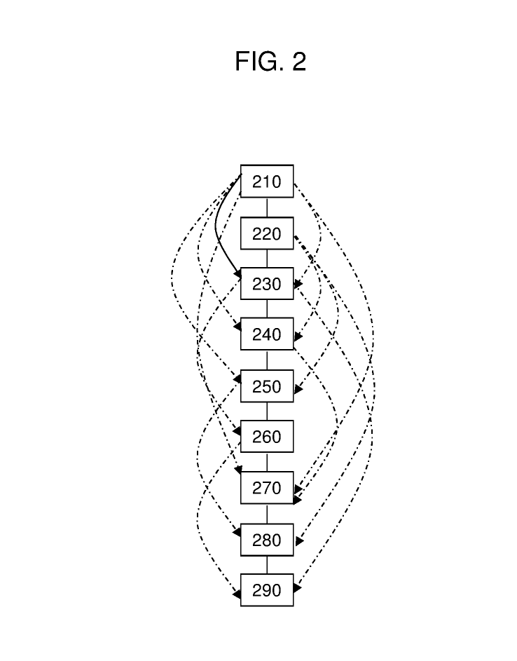

FIG. 2: Exemplary Method

In block 210, parameters of one or more products and services may be specified, e.g., to the server 2. For example, providers may specify parameters concerning products and services they are willing to provide, and recipients may specify parameters concerning products and services they are willing to acquire, borrow, or otherwise obtain possession or other rights in. Parameters may comprise specifications concerning delivery obligations (e.g., concerning time of delivery), price, interest rate, term, penalties for failure to pay, remedies, commitment specifications, quantity, and other specifications. Parameters may also comprise specifications concerning a margin amount, and terms concerning the whole or partial surrender of the margin amount (e.g., upon one or more failure conditions relating to obligations of provider commitment or recipient conditions). Parameters may also comprise specifications concerning a one-time or recurring commitment fee payment.

For example, a provider such as a lender may specify terms (or ranges of terms) of a loan it commits to provide, e.g., to a borrower that meets various criteria (such as meeting a threshold credit score and household or personal income). A borrower may specify terms (or ranges of terms) of a loan it is willing to take. Terms may include delivery obligations concerning the principal amount of the loan, including a required time of delivery upon a recipient's acceptance of a provider's commitment.

Parameters may be specified, e.g., at a user interface of a recipient 10 or provider 8. Specifications may be transmitted to server and/or other system elements. Parameters may comprise ranges of terms, such as a range of interest rates (e.g., 3.5% to 3.7%), rangers of principal amounts (e.g., $95,000 to $105,000), ranges of delivery times (e.g., delivery of principal to occur between two days from acceptance of commitment to ten days after acceptance of commitment, or between specified dates or times such as 5 pm January 5 to 10 am January 10). Parameters may be variable, such as interest rates tied to LIBOR (e.g., “LIBOR plus 1%” as measured on the date of acceptance of commitment).

In block 220, a provider may cause a portion of the commitment amount to be transferred, e.g., to an account associated with server 2 and/or to one or more agents 12. For example, a lender who commits to provide a $100,000 loan may cause 5% of the loan amount (i.e., $5,000) to be transferred to a server account or an escrow agent. Confirmation of such transfer may be transmitted to one or more parties, such as to server, one or more recipients, one or more providers, and one or more agents. In some embodiments, server 2 may validate the commitment once it is determined that the “margin” amount has been transferred and/or received.

In block 230, a commitment fee may be paid to the provider, e.g., by a server account or an agent 12. The commitment fee may comprise a form of recompense for the binding commitment of the provider, and may encourage the provider (and other providers) to submit additional commitments. The commitment fee may be paid once or may be a recurring fee, e.g., paid periodically (e.g., once every week, bi-weekly, monthly, bi-monthly, yearly, etc.).

In block 240, a plurality of product and/or service commitments (e.g., those that has been validated pursuant to transfer of a margin amount) may be tracked, managed, and output by server 2. The commitments may be displayed to users such as recipients 10 and providers 8, e.g., at an interface, e.g., pursuant to a search for commitments that satisfy one or more search parameters.

A recipient may select and accept a specific commitment from a specific provider from among a plurality of possible commitments. For example, the recipient may accept a specific provider's commitment to provide 100 gallons of oil during a specific period of time. The server may send a message to the provider indicating that the specific recipient accepted the commitment.

In some embodiments, the recipient and/or provider may modify and/or renegotiate one or more terms of the commitment. For example, the recipient may select the commitment but request to negotiate one or more terms prior to full acceptance of the contract. For example, the recipient (or provider) may request to move the date of delivery of the loan proceeds by one week, or may elect to eliminate, reduce, or otherwise renegotiate a loan prepayment penalty. In some embodiments, once a recipient selects and/or accepts a commitment, a provider may have or be offered an opportunity to slightly amend various terms of the commitment prior to the commitment becoming a binding contract. For example, the provider may have the right to slightly modify delivery or other terms (e.g., to delay delivery by one or two days, or reduce the principal amount by 1%) before finalizing the contract.

In some embodiments, the provider and recipient may share information to renegotiate terms that are more favorable to both of them. For example, a recipient may reveal that it is willing to delay a delivery obligation in return for a lower price or interest rate, and this may be preferable for and agreeable to the provider.

In block 250, the margin amount associated with the accepted commitment may be transmitted, delivered, and/or otherwise transferred to the recipient. For example, 10 gallons of oil held in escrow may be physically delivered to an address associated with the recipient, e.g., at the designated time. In some embodiments, the 10 gallons of oil may stay in the same physical location, but ownership or other rights to the 10 gallons may be transferred to another entity such as an escrow entity.

In block 260, the provider may fail to satisfy one or more parameters of the commitment. For example, the provider may fail to deliver the total committed quantity of oil (or loan principal) at the designated time, or may only partially meet various requirements. In some embodiments, the provider may send a message to the server and/or recipient indicating that the provider expects to breach one or more requirements of the commitment.

In block 270, a surrender amount may be determined. The surrender amount may comprise all or a portion of the margin amount. All or a portion of the surrender amount may be paid and/or transferred/delivered to one or more payees/receivers, such as the original recipient, server account, and/or an escrow agent. The surrender amount may be determined based on various factors, e.g., as described herein. Additional penalties (e.g., against the provider) may be assessed, e.g., a surrender of one or more commitment fee payments.

In block 280, the provider and recipient may negotiate a new commitment, or amend terms of the original commitment.

In some embodiments, the recipient may elect to cancel the commitment and keep all or a portion of the margin amount. The recipient may or may not search for, select, and/or accept one or more other commitments (e.g., to replace a commitment cancelled as a result of a breach). A fee or penalty may be assessed against the provider. The recipient may be required to return any delivered portion of the commitment (e.g., other than all or part of the margin amount).

In block 290, rating information may be stored and tracked based on any violations of any commitment terms by providers and recipients.

It should be appreciated that the actions described in the blocks for the methods described herein are exemplary only, and need not be performed in the order presented here. Further, it is not necessary to accomplish all of the actions described in the blocks. Rather, any number of the blocks (e.g., four of the blocks or six of the blocks) may be accomplished, and in any order. Further, the actions described herein may be combined with any other actions described herein, in any order.

It should be appreciated that in some embodiments, instead of transferring a margin amount of the commitment amount, an escrow payment may be made. For example, with respect to a commitment to provide 1000 gallons of oil, instead of transferring 100 barrels of oil (or title or rights to such 100 barrels) to an agent, a payment (e.g., escrow payment) may be made to the agent, e.g., in the amount of the current market value of 100 barrels of oil.

While many features and embodiments are described with reference to loans (and borrowers and lenders etc.), it should be appreciated that the features and embodiments may be modified to apply to other products and services, e.g., durable goods, oil, bandwidth (e.g., bandwidth for transmitting information via the internet, RF spectrum bandwidth, or other bandwidth), delivery services, driver provider services (such as Uber), oil, water, gold, commodities, and other products and services.

For example, a lender's commitment to provide a loan to a borrower is analogous to an oil provider's commitment to provide a quantity of a commodity or durable good such as oil, corn, gold, or cars to a recipient/purchaser/borrower/acquirer of such goods. For example, a provider of oil is analogous to a provider of a loan, and purchase/acquirer/borrower of oil is analogous to a borrower with respect to a loan. Similarly, a commitment to provide a loan principal is analogous to a commitment to provide a specified amount of gold or oil to a potential recipient. Similarly, surrenderable margins of a loan are analogous to a surrenderable portion of the committed quantity of oil, gold, corn, cars, etc. Where possible, when the above description discusses features of embodiments related to loans, it should be understood that those features may also be applied to other goods and services. Further, it should be appreciated that while the term “margin” is used to refer to a portion of a loan amount from a lender that is initially held by a party other than the lender (e.g., an entity associated with server 2, or an escrow entity 12) for an eventual recipient 10 and that in some embodiments can be wholly or partially forfeit by the lender, the term “margin” may also be used herein to refer to an amount of a product or service from a provider 8 that is held by a party other than the provider (e.g., in escrow for an eventual recipient 10) and that in some embodiments can be wholly or partially surrendered. One of ordinary skill in the art will appreciate that these terms may be applied to analogous items in analogous embodiments.

It should be appreciated that any product or service for which a wholly or partially surrenderable margin can be provided is contemplated herein. Such examples further include durable goods such as cars, diamonds, jewelry, real estate (e.g., real estate ownership or leasing). It should also be appreciated that the features described herein may also be implemented via legal rights in products and services, such as licenses, leases, and other rights to have, transfer, use, etc.

In some embodiments, a provider may commit to provide a number of drivers in a geographical area for a specified period of time. For example, as a margin amount, the provider may provide (e.g., to an agent or escrow entity, or to server) indicia indicating legal rights to a percentage of the committed number of drivers for the relevant time period.

In various embodiments, the trading systems described in U.S. Patent Publication No. 2014/0229353 to Lutnick et al., entitled “SYSTEMS AND METHODS FOR DETECTING INTEREST AND VOLUME MATCHING,” and in U.S. Patent Publication No. 2004/0034591 to Waelbroeck, entitled “Method and system for managing distributed trading data,” may be configured to implement the features described herein. It should be appreciated that networked computers and matching systems as described in these patent applications may be configured to implement these features.

The disclosures of the above-identified applications, and all other patent applications and other documents referenced in this patent application, are incorporated by reference herein in their entireties.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

The following are exemplary embodiments:

A1. A method comprising:

receiving, by at least one processor in electronic communication with a plurality of user computer terminals via an electronic communications network, from a provider of a tangible good one or more parameters defining a commitment to provide the tangible good, the parameters comprising a quantity parameter defining an amount of the tangible good to be provided to a recipient and a delivery parameter specifying information about when a recipient would receive the amount of the tangible good;

receiving, by at least one processor, indicia that the provider caused a portion of the amount of the tangible good to be physically delivered to and held by an escrow associated with the commitment to provide the tangible good;

determining, by the at least one processor, a commitment fee based on the portion held in escrow;

causing the commitment fee to be paid to an account associated with the provider;

receiving, by the at least one processor, from a receiving party a request to accept the commitment to provide the tangible good;

receiving, by the at least one processor, from the receiving party a request for the provider to deliver the tangible good to the receiving party in an amount that satisfies the quantity parameter;

transmitting, by the at least one processor, to the provider a request to physically deliver to the receiving party a remaining portion of the amount of the tangible good that is not held in escrow, the remaining portion comprising an amount of the tangible good that satisfies the quantity parameter less the portion of the tangible good held in escrow;

determining that the provider failed to transfer the remaining portion of the tangible good before an expiration time pursuant to the delivery parameter;

responsive to determining that the provider failed to deliver the remaining portion of the tangible good before the expiration time, notifying the provider that at least a part of the portion held in escrow has been forfeit by the provider;

after notifying the provider that at least a part of the portion held in escrow has been forfeit by the provider, transmitting an instruction that causes the at least part of the portion held in escrow to be physically delivered to another location.

A2. The method of embodiment A1, in which the tangible good comprises at least one of oil and potable water.

A3. A method comprising:

receiving, by at least one processor, from a provider one or more parameters defining a commitment to provide a quantity of a product according to one or more delivery parameters;

receiving, by at least one processor, indicia that the provider transferred a margin amount of the product associated with the commitment to provide the quantity of the product to be held in escrow by an escrow entity;

determining, by the at least one processor, a commitment fee based on the commitment to provide the quantity of the product;

causing the commitment fee to be paid to an account associated with the provider;

receiving, by the at least one processor, from a recipient an acceptance of the commitment to provide the quantity of the product;

transmitting, by the at least one processor, to the provider a request to transfer to the recipient a remaining portion of the quantity of the product, the remaining portion comprising the quantity less the margin amount;

determining that the provider failed to satisfy the one or more delivery parameters; and

responsive to determining that the lender failed to transfer the remaining portion of the loan principal amount before the expiration time, notifying the provider that at least a portion of the margin amount has been forfeit.

A4. The method of embodiment A3, in which the act of determining that the provider failed to satisfy the one or more delivery parameters comprises:

determining that the provider failed to transfer the remaining portion of the quantity before an expiration time.

A5. The method of embodiment A3, in which the provider is a lender, the recipient is a borrower, the commitment to provide a quantity of a product comprises a commitment to provide a loan in the amount of a loan principal amount, the margin amount comprises a loan margin amount, and the commitment fee comprises a loan commitment fee.

A6. The method of embodiment A3, further comprising:

prior to notifying the provider that at least a portion of the margin amount has been forfeit, determining an amount of the margin amount that has been forfeit based at least in part on one or more of the following:

an availability of a similar commitment to the recipient;

an amount of product delivered to the recipient pursuant to the commitment;

a timeliness of delivery of any portion of the quantity of the product pursuant to the commitment;

a notice provided by the provider to the recipient in advance of any breach;

an attempt by the provider to renegotiate the commitment in good faith; and

a payment made by the provider to the recipient with respect to a failure to satisfy one or more requirements of the commitment.

A7. The method of embodiment A3, in which the margin amount satisfies at least a portion of a margin requirement for at least one un-accepted commitment offered by the provider.

A8. The method of embodiment A3, in which the product is bandwidth for transferring data, and in which the margin amount comprises a right to receive a margin amount of bandwidth.

A9. The method of embodiment A3, in which the product comprises a quantity of delivery or transportation providers in a designated geographic region for a designated period of time, and in which the margin amount comprises a right to receive a percentage of the quantity of delivery or transportation providers.

A10. The method of embodiment A3, in which the product comprises one of oil and water.

A11. The method of embodiment A3, in which the product comprises a commodity.

A12. The method of embodiment A3, in which the act of determining a commitment fee comprises determining a commitment fee based at least in part on at least one of (1) an extent to which terms of the commitment differ from market terms and (2) a length of time that the commitment has been pending and unaccepted by a recipient.

A13. The method of embodiment A3, further comprising:

after determining that the provider failed to satisfy the one or more delivery parameters, causing at least a portion of the margin amount to be transferred to another party.

A14. The method of embodiment A3, further comprising:

after determining that the provider failed to satisfy the one or more delivery parameters, causing at least a portion of the margin amount to be transferred back to the provider.

A15. The method of embodiment A3, further comprising, before the act of receiving from a recipient an acceptance of the commitment to provide the quantity of the product:

receiving from the recipient a request to view information about a plurality of commitments that satisfy one or more search parameters;

transmitting to the recipient information about a plurality of commitments that satisfy the one or more search parameters, the plurality of commitments comprising the commitment; and

receiving from the recipient, via an input device of the recipient, a selection and acceptance of the commitment.

A16. An apparatus comprising:

at least one processor in electronic communication with a plurality of computers via a network; and

at least one memory, in electronic communication with the at least one processor, having instructions stored thereon which, when executed by the at least one processor, direct the at least one processor to perform the method of any of embodiments 1-16.

A17. A non-transitory machine-readable medium having instructions stored thereon that are configured to, when executed by the at least one processor, direct the at least one processor to perform the method of any of embodiments 1-16.

Various additional embodiments may be considered.

1. A method comprising:
receiving, by at least one processor in electronic communication with a plurality of user computer terminals via an electronic communications network, from a provider of a tangible good one or more parameters defining a commitment to provide the tangible good, the parameters comprising a quantity parameter defining an amount of the tangible good to be provided to a recipient and a delivery parameter specifying information about when a recipient would receive the amount of the tangible good;
receiving, by at least one processor, indicia that the provider caused a portion of the amount of the tangible good to be physically delivered to and held by an escrow associated with the commitment to provide the tangible good;
determining, by the at least one processor, a commitment fee based on the portion held in escrow;
causing the commitment fee to be paid to an account associated with the provider;
receiving, by the at least one processor, from a receiving party a request to accept the commitment to provide the tangible good;
receiving, by the at least one processor, from the receiving party a request for the provider to deliver the tangible good to the receiving party in an amount that satisfies the quantity parameter;
transmitting, by the at least one processor, to the provider a request to physically deliver to the receiving party a remaining portion of the amount of the tangible good that is not held in escrow, the remaining portion comprising an amount of the tangible good that satisfies the quantity parameter less the portion of the tangible good held in escrow;
determining that the provider failed to transfer the remaining portion of the tangible good before an expiration time pursuant to the delivery parameter;
responsive to determining that the provider failed to deliver the remaining portion of the tangible good before the expiration time, notifying the provider that at least a part of the portion held in escrow has been forfeit by the provider; and
after notifying the provider that at least a part of the portion held in escrow has been forfeit by the provider, transmitting an instruction that causes the at least part of the portion held in escrow to be physically delivered to another location.

2. The method of claim 1, in which the tangible good comprises at least one of oil and potable water.

3. A method comprising:
receiving, by at least one processor, from a provider one or more parameters defining a commitment to provide a quantity of a product according to one or more delivery parameters;
receiving, by at least one processor, indicia that the provider transferred a margin amount of the product associated with the commitment to provide the quantity of the product to be held in escrow by an escrow entity;
determining, by the at least one processor, a commitment fee based on the commitment to provide the quantity of the product;
causing the commitment fee to be paid to an account associated with the provider;
receiving, by the at least one processor, from a recipient an acceptance of the commitment to provide the quantity of the product;
transmitting, by the at least one processor, to the provider a request to transfer to the recipient a remaining portion of the quantity of the product, the remaining portion comprising the quantity less the margin amount;
determining that the provider failed to satisfy the one or more delivery parameters; and
responsive to determining that the lender failed to transfer the remaining portion of the loan principal amount before the expiration time, notifying the provider that at least a portion of the margin amount has been forfeit.

4. The method of claim 3, in which the act of determining that the provider failed to satisfy the one or more delivery parameters comprises:
determining that the provider failed to transfer the remaining portion of the quantity before an expiration time.

5. The method of claim 3, in which the provider is a lender, the recipient is a borrower, the commitment to provide a quantity of a product comprises a commitment to provide a loan in the amount of a loan principal amount, the margin amount comprises a loan margin amount, and the commitment fee comprises a loan commitment fee.

6. The method of claim 3, further comprising:
prior to notifying the provider that at least a portion of the margin amount has been forfeit, determining an amount of the margin amount that has been forfeit based at least in part on one or more of the following:
an availability of a similar commitment to the recipient;
an amount of product delivered to the recipient pursuant to the commitment;
a timeliness of delivery of any portion of the quantity of the product pursuant to the commitment;
a notice provided by the provider to the recipient in advance of any breach;
an attempt by the provider to renegotiate the commitment in good faith; and
a payment made by the provider to the recipient with respect to a failure to satisfy one or more requirements of the commitment.

7. The method of claim 3, in which the margin amount satisfies at least a portion of a margin requirement for at least one un-accepted commitment offered by the provider
in which the product is bandwidth for transferring data, and in which the margin amount comprises a right to receive a margin amount of bandwidth.

8. (canceled)

9. The method of claim 3, in which the product comprises a quantity of delivery or transportation providers in a designated geographic region for a designated period of time, and in which the margin amount comprises a right to receive a percentage of the quantity of delivery or transportation providers.

10-11. (canceled)

12. The method of claim 3, in which the act of determining a commitment fee comprises determining a commitment fee based at least in part on at least one of (1) an extent to which terms of the commitment differ from market terms and (2) a length of time that the commitment has been pending and unaccepted by a recipient.

13. The method of claim 3, further comprising:
after determining that the provider failed to satisfy the one or more delivery parameters, causing at least a portion of the margin amount to be transferred to another party,
in which the product comprises one of oil and water.

14. The method of claim 3, further comprising:
after determining that the provider failed to satisfy the one or more delivery parameters, causing at least a portion of the margin amount to be transferred back to the provider,
in which the product comprises a commodity.

15. The method of claim 3, further comprising, before the act of receiving from a recipient an acceptance of the commitment to provide the quantity of the product:
receiving from the recipient a request to view information about a plurality of commitments that satisfy one or more search parameters;
transmitting to the recipient information about a plurality of commitments that satisfy the one or more search parameters, the plurality of commitments comprising the commitment; and
receiving from the recipient, via an input device of the recipient, a selection and acceptance of the commitment.

16. A method comprising:
receiving, by at least one processor, from a lender one or more parameters defining a loan commitment associated with a loan having a loan principal amount;
receiving, by at least one processor, indicia that the lender paid a margin amount associated with the loan principal amount;
determining, by the at least one processor, a loan commitment fee based on the loan principal amount;
causing the commitment fee to be paid to an account associated with the lender;
receiving, by the at least one processor, from a borrower a request to enter into the loan with the lender;
transmitting, by the at least one processor, to the lender a request to transfer a remaining portion of the loan principal amount, the remaining portion comprising the loan principal amount less the margin amount;
determining that the lender failed to transfer the remaining portion of the loan principal amount before an expiration time; and
responsive to determining that the lender failed to transfer the remaining portion of the loan principal amount before the expiration time, notifying the lender that at least a portion of the margin amount has been forfeit.

17. The method of claim 16, in which the loan commitment fee comprises a plurality of payments to the lender over a period of time, in which the payments and payment times are determined based on the loan principal amount and one of an interest rate and a percentage,
in which payments of the commitment fee are no longer paid after the act of notifying the lender that the margin amount has been surrendered.

18. (canceled)

19. The method of claim 16, further comprising:
after determining that the lender failed to transfer the remaining portion of the loan principal amount before an expiration time, offering lender terms of the loan to one or more other lenders.

20. The method of claim 16, further comprising:
prior to notifying the lender that at least a portion of the margin amount has been forfeit, determining an amount of the margin amount that has been forfeit based at least in part on one or more of the following:
an availability of a similar commitment to the recipient;
an amount of product delivered to the recipient pursuant to the commitment;
a timeliness of delivery of any portion of the quantity of the product pursuant to the commitment;
a notice provided by the provider to the recipient in advance of any breach;
an attempt by the provider to renegotiate the commitment in good faith; and
a payment made by the provider to the recipient with respect to a failure to satisfy one or more requirements of the commitment.

21. The method of claim 16, further comprising:
receiving a first offer to accept the loan terms from at least one first lending entity;
receiving a second offer to accept the loan terms from at least one second lending entity;
determining that the second offer is a best offer to accept the loan terms from among a plurality of received offers including the first offer and the second offer; and
matching the at least one second lending entity and the borrower for a transaction comprising the loan.

22. The method of claim 21,
in which the first offer comprises a first amount associated with the margin amount that would be paid to the at least one first lending entity,
in which the second offer comprises a second amount associated with the margin amount that would be paid to the at least one first lending entity, in which the second amount is lower than the first amount, and
in which the act of determining that the second offer is the best offer comprises determining that the second amount is less than at least one other amount, the at least one other amount comprising the first amount, further comprising:
causing to be paid to the at least one second lending entity the second amount.

23. The method of claim 16, further comprising:
determining to refund a refund portion of the margin amount to the lender; and
refunding the refund portion of the margin amount to the lender.

24. The method of claim 23, in which the act of determining to refund a refund portion of the margin amount to the lender comprises determining the refund portion based on an amount of time that elapsed before one or more other lenders accepted lending obligations of the lender associated with the loan accepted by the borrower,
in which the act of notifying the lender that at least a portion of the margin amount has been forfeit comprises notifying the lender that the margin amount has been forfeit.

25. (canceled)

26. The method of claim 16, further comprising:
causing at least a portion of the margin amount to be paid to the borrower.

27-28. (canceled)
